(19) United States
(12) Patent Application Publication
(10) Pub. No.: US 2023/0191463 A1
(43) Pub. Date: Jun. 22, 2023

(54) Drain Cleaning Device Used With A Chemical Cleaning Fluid

(71) Applicants: Stephen S. Turner, Edelstein, IL (US); Scott I. Turner, Chillicothe, IL (US)

(72) Inventors: Stephen S. Turner, Edelstein, IL (US); Scott I. Turner, Chillicothe, IL (US)

(21) Appl. No.: 18/087,744

(22) Filed: Dec. 22, 2022

Related U.S. Application Data
(60) Provisional application No. 63/292,900, filed on Dec. 22, 2021.

(51) Int. Cl. B08B 9/043; E03C 1/302; A46B 11/00; A46B 5/00

(52) U.S. Cl. CPC B08B 9/0436; E03C 1/302; A46B 11/0041; A46B 11/0062; A46B 11/0065; A46B 11/0086; A46B 5/005; B08B 2209/04; A46B 2200/3013

(57) ABSTRACT

A drain cleaning device for removing debris from a drain is disclosed herein. The drain cleaning device includes a fluid container section with a fluid reservoir for holding a chemical cleaning fluid therein; an elongated rod section having a first end being connected to the fluid container section, the elongated rod section defining a fluid passageway configured to be fluidly coupled to the fluid reservoir of the fluid container section for conveying the chemical cleaning fluid; and a tip section connected to a second end of the elongated rod section, the tip section including a central core portion and a plurality of protruding elements, the tip section further including a fluid aperture fluidly coupled to the fluid passageway of the elongated rod section so as to enable the chemical cleaning fluid to be discharged from the fluid aperture of the tip section to a drain pipe.

### CROSS-REFERENCE TO RELATED APPLICATIONS

This patent application claims priority to, and incorporates by reference in its entirety, U.S. Provisional Patent Application No. 63/292,900, entitled “Drain Cleaning Apparatus And Method”, filed on Dec. 22, 2021.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF THE INVENTION

### 1. Field of the Invention

The invention generally relates to a drain cleaning device. More particularly, the invention relates to a drain cleaning device used with a chemical cleaning fluid.

### 2. Background

Bathroom drains are clogged most often by hair that enters the drain and collects from the drain trap at the bottom up to the drain opening. Most frequently, the hair combines with sticky products such as soap, shampoo, and toothpaste and builds a “log-jam” of sorts where these drain obstructions catch the hair, and some settles in the drain trap. After sufficient amounts of hair have collected in the drain trap or around the upper opening, the water from the sink basin begins to drain noticeably more slowly, and eventually can completely block the water from draining. Home remedies, such as baking soda and vinegar, and plungers are frequently used for these clogs, but often fail to dissolve or dislodge the hair clogging the drain. In extreme cases, the only remaining remedy is to disassemble the drain or use a device that can effectively reach, snag, and extract the hair (e.g., a drain snake).

Therefore, what is needed is needed is a drain cleaning device used with a chemical cleaning fluid for cleaning a bathroom drain or other type of drain that is capable of unblocking the drain of accumulated hair and other debris.

### BRIEF SUMMARY OF EMBODIMENTS OF THE INVENTION

Accordingly, the present invention is directed to a drain cleaning device used with a chemical cleaning fluid that substantially obviates one or more problems resulting from the limitations and deficiencies of the related art.

In accordance with one or more embodiments of the present invention, there is provided a drain cleaning device for removing debris from a drain. The drain cleaning device includes a fluid container section, the fluid container section comprising a fluid reservoir for holding a chemical cleaning fluid therein; an elongated rod section having a first end and a second end oppositely disposed relative to the first end, the first end of the elongated rod section being connected to the fluid container section, the elongated rod section defining a fluid passageway configured to be fluidly coupled to the fluid reservoir of the fluid container section for conveying the chemical cleaning fluid; and a tip section connected to the second end of the elongated rod section, the tip section including a central core portion and a plurality of protruding elements extending from the central core portion, the plurality of protruding elements configured to remove debris from a drain pipe, the tip section further including a fluid aperture fluidly coupled to the fluid passageway of the elongated rod section so as to enable the chemical cleaning fluid to be discharged from the fluid aperture of the tip section to the drain pipe.

In a further embodiment of the present invention, the fluid container section is in a form of a squeeze bulb formed from a flexible material, the squeeze bulb comprising the fluid reservoir for holding the chemical cleaning fluid therein, and the squeeze bulb configured to be squeezed by a user so as to discharge the chemical cleaning fluid from the drain cleaning device.

In yet a further embodiment, the drain cleaning device further comprises a detachable handle section having a proximal end portion and a distal end portion, the distal end portion of the detachable handle section being configured to be coupled to a proximal end portion of the squeeze bulb.

In still a further embodiment, the fluid container section, the elongated rod section, and the tip section are formed together with a handle section as part of a one-piece device construction, the handle section having a proximal end portion and a distal end portion, the distal end portion of the handle section being connected to a proximal end portion of the squeeze bulb.

In yet a further embodiment, the drain cleaning device further comprises a plug member that is configured to engage a distal end portion of the tip section, wherein the plug member is configured to prevent a leakage of the chemical cleaning fluid from the fluid aperture of the tip section.

In still a further embodiment, the tip section further comprises a plurality of brush bristles attached to the central core portion, and the plurality of protruding elements of the tip section are formed by the plurality of brush bristles.

In yet a further embodiment, the tip section further comprises an outer covering formed from a hook material strip that is bonded to the central core portion of the tip section, the hook material strip forming the plurality of protruding elements of the tip section.

In still a further embodiment, the plurality of protruding elements are in a form of a plurality of injection-molded micro-hook elements.

In yet a further embodiment, the drain cleaning device further comprises a handle section having a proximal end portion and a distal end portion, the distal end portion of the handle section being configured to be coupled to the first end of the elongated rod section; and the fluid container section is in a form of a removable cartridge configured to be selectively engaged with the handle section, the removable cartridge comprising the fluid reservoir for holding the chemical cleaning fluid therein, and the removable cartridge configured to be replaceable by a user when the chemical cleaning fluid is emptied from the removable cartridge.

In still a further embodiment, the fluid container section is in a form of a detachable bottle that includes a first connector portion, the detachable bottle comprising the fluid reservoir for holding the chemical cleaning fluid therein, and the first end of the elongated rod section comprising a second connector portion that is configured to engage with the first connector portion on the detachable bottle for removably coupling the detachable bottle to the elongated rod section.

In yet a further embodiment, the fluid container section is in a form of a detachable handle that includes a first connector portion, the detachable handle comprising the fluid reservoir for holding the chemical cleaning fluid therein, and the first end of the elongated rod section comprising a second connector portion that is configured to engage with the first connector portion on the detachable handle for removably coupling the detachable handle to the elongated rod section.

In still a further embodiment, the fluid container section is in a form of a bottle that includes a bottle cap member, the bottle comprising the fluid reservoir for holding the chemical cleaning fluid therein, and the elongated rod section and the tip section of the drain cleaning device are configured to be housed inside the bottle.

In yet a further embodiment, the drain cleaning device further comprises a sleeve member configured to be inserted into the bottle, the elongated rod section and the tip section of the drain cleaning device configured to be housed within the sleeve member inside the bottle so as to isolate the elongated rod section and the tip section of the drain cleaning device from the chemical cleaning fluid when the elongated rod section and the tip section of the drain cleaning device are being stored inside the bottle.

In still a further embodiment, when the drain cleaning device is ready to be used, the sleeve member, and the elongated rod section and the tip section of the drain cleaning device housed therein are configured to be removed from the inside of the bottle, and the first end of the elongated rod section of the drain cleaning device is configured to be attached to a mouth of the bottle by means of the bottle cap member so that the chemical cleaning fluid from the fluid reservoir of the bottle is able to be discharged from the fluid aperture of the tip section.

In yet a further embodiment, the elongated rod section of the drain cleaning device comprises a first tubular member telescopically received within a second tubular member, the second tubular member configured to be extended from the first tubular member so as to increase an overall length of the drain cleaning device for reaching deeper into the drain pipe.

In accordance with one or more other embodiments of the present invention, there is provided a drain cleaning device for removing debris from a drain. The drain cleaning device including a handle section, the handle section configured to accommodate a hand of a user during a spinning of the drain cleaning device by the user; an elongated rod section having a first end and a second end oppositely disposed relative to the first end, the first end of the elongated rod section being connected to the handle section; and a tip section connected to the second end of the elongated rod section, the tip section including a central core portion and a plurality of protruding elements extending from the central core portion, the plurality of protruding elements configured to remove debris from the drain pipe. In these one or more other embodiments, the drain cleaning device is configured to be stored inside a fluid container, the fluid container comprising a fluid reservoir for holding a chemical cleaning fluid therein, and the fluid container further comprising a cap member configured to enclose the drain cleaning device within the fluid container.

In a further embodiment of the present invention, the drain cleaning device further comprises a sleeve member configured to be inserted into the fluid container, the elongated rod section and the tip section of the drain cleaning device configured to be housed within the sleeve member inside the fluid container so as to isolate the elongated rod section and the tip section of the drain cleaning device from the chemical cleaning fluid when the elongated rod section and the tip section of the drain cleaning device are being stored inside the fluid container.

In yet a further embodiment, the elongated rod section of the drain cleaning device comprises a first rod member telescopically received within a second rod member, the second rod member configured to be extended from the first rod member so as to increase an overall length of the drain cleaning device for reaching deeper into the drain pipe.

It is to be understood that the foregoing general description and the following detailed description of the present invention are merely exemplary and explanatory in nature. As such, the foregoing general description and the following detailed description of the invention should not be construed to limit the scope of the appended claims in any sense.

### BRIEF DESCRIPTION OF THE SEVERAL VIEWS OF THE DRAWINGS

The invention will now be described, by way of example, with reference to the accompanying drawings, in which:

FIG. 1 is a perspective view of a drain cleaning device, according to a first illustrative embodiment of the invention, wherein the drain cleaning device includes a fluid container section in a form of a squeeze bulb and a detachable handle;

FIG. 2 is an exploded perspective view of the drain cleaning device of FIG. 1;

FIG. 3 is a longitudinal sectional view cut through the drain cleaning device of FIG. 1, wherein the section is generally cut along the cutting-plane line A-A in FIG. 1;

FIG. 4 is a perspective view of a drain cleaning device, according to a second illustrative embodiment of the invention, wherein the drain cleaning device includes a fluid container section in a form of a squeeze bulb and an integral handle;

FIG. 5 is a longitudinal sectional view cut through the drain cleaning device of FIG. 4, wherein the section is generally cut along the cutting-plane line B-B in FIG. 4;

FIG. 6 is an exploded perspective view of the drain cleaning device of FIG. 4;

FIG. 7 is a perspective view of a drain cleaning device, according to a third illustrative embodiment of the invention, wherein the drain cleaning device includes a fluid container section in a form of a removable cartridge in the handle;

FIG. 8 is a longitudinal sectional view cut through the drain cleaning device of FIG. 7, wherein the section is generally cut along the cutting-plane line C-C in FIG. 7;

FIG. 9 is an exploded perspective view of the drain cleaning device of FIG. 7;

FIG. 10 is a perspective view of a drain cleaning device, according to a fourth illustrative embodiment of the invention, wherein the drain cleaning device includes a fluid container section in a form of a detachable handle;

FIG. 11 is a longitudinal sectional view cut through the drain cleaning device of FIG. 10, wherein the section is generally cut along the cutting-plane line D-D in FIG. 10;

FIG. 12 is an exploded perspective view of the drain cleaning device of FIG. 10;

FIG. 13 is a perspective view of a drain cleaning device, according to a fifth illustrative embodiment of the invention, wherein the drain cleaning device includes a fluid container section in a form of a detachable bottle;

FIG. 14 is an exploded perspective view of the drain cleaning device of FIG. 13;

FIG. 15 is an exploded perspective view of a drain cleaning device, according to a sixth illustrative embodiment of the invention, wherein an elongated rod section and a tip section of the drain cleaning device is configured to be housed in a sleeve within a bottle;

FIG. 16 is another exploded perspective view of the drain cleaning device of FIG. 15, wherein the elongated rod section and the tip section of the drain cleaning device is shown inverted for use; and

FIG. 17 is a perspective view of a drain cleaning device, according to a seventh illustrative embodiment of the invention, wherein an elongated rod section and a tip section of a solid drain cleaning device is configured to be housed in a sleeve within a bottle.

Throughout the figures, the same parts are always denoted using the same reference characters so that, as a general rule, they will only be described once.

### DETAILED DESCRIPTION OF EMBODIMENTS OF THE INVENTION

The illustrative embodiments of the present disclosure can provide for a drain cleaning device and method. The drain cleaning device can include a chemical cleaner that works in conjunction with the drain cleaner. Illustrative embodiments of the various methods and devices will now be described with reference to the figures. The following description of the various embodiments is merely exemplary in nature and is in no way intended to limit the scope of the disclosure, its application, or uses.

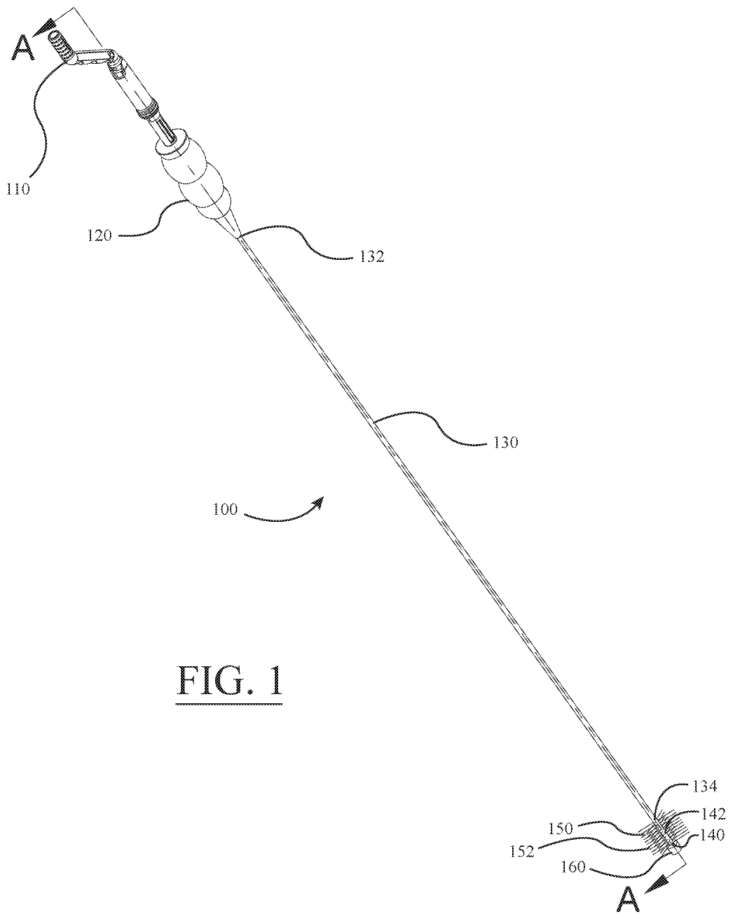

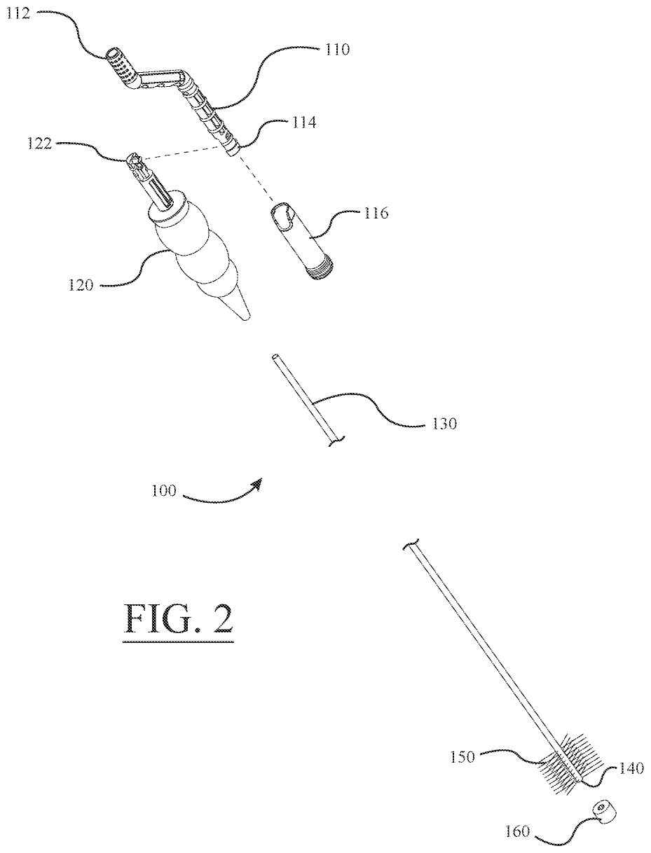

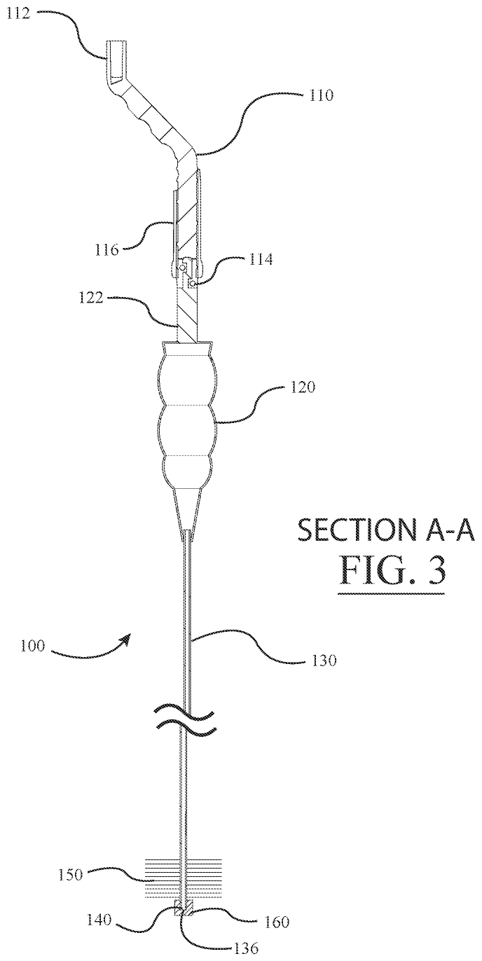

A first illustrative embodiment of a drain cleaning device is seen generally at 100 in FIGS. 1-3. More specifically, FIG. 1 illustrates a drain cleaning device 100 that can have a handle 110 with rotatable sleeve member 116. The handle 110 can be removable. For example, a user can remove the handle 110 and then reattach the handle 110. The detachable handle 110 has a proximal end portion 112 and a distal end portion 114. A squeeze bulb 120 can be included and a top portion of the squeeze bulb 120 can be attached to the handle 110. In the illustrative embodiment, the distal end portion 114 of the detachable handle 110 is configured to be coupled to a proximal end portion 122 of the squeeze bulb 120. The squeeze bulb 120 can include a chemical that can be used to help dissolve hair, soap scum and other waste that can be stuck in the drain. Various chemicals can be used, such as but not limited to bleach, hydrochloric acid or any other chemical or combination thereof to help dissolve hair, soap, grease or other waste commonly found in drains. An elongated hollow rod section 130 can be connected under the squeeze bulb 120, having a hollow interior that allows the chemical to flow through the elongated rod section 130. The elongated rod section 130 has a first end 132 and a second end 134 oppositely disposed relative to the first end 132. A distal tip 140 is provided at the bottom (second end 134) of the elongated rod section 130. A brush 150 having a plurality of bristles 152 extending from a central core portion 142 can be provided at the distal tip 140 to help clean debris from the drain. In some exemplary embodiments, a plug 160 can be provided at the distal tip 140 to prevent the chemical from dripping through the fluid aperture 136 of the distal tip 140. Like the first illustrative embodiment, the illustrative embodiments described hereinafter similarly have brushes 250, 350, 450, 550, 650 and plugs 260, 360, 460, 560, 660.

In use, a user can remove the plug 160 and place the drain cleaning device 100 inside a drain such that the elongated rod section 130, which can be flexible, will conform to the shape of the drain. Once in position, the user can squeeze the squeeze bulb 120 which contains the chemical. The chemical will flow through the elongated rod section 130 and be released from the fluid aperture 136 at the bottom of the distal tip 140. In some exemplary embodiments, the user can remove the handle 110 and refill the chemical in the squeeze bulb 120 for additional uses.

In the illustrative embodiment, as shown in FIG. 1, the detachable handle 110 and the structure of the handle connectors may be similar to the detachable handle 102 in FIGS. 19-30 of co-pending U.S. patent application Ser. No. 17/556,852, the entire disclosure of which is incorporated herein by reference).

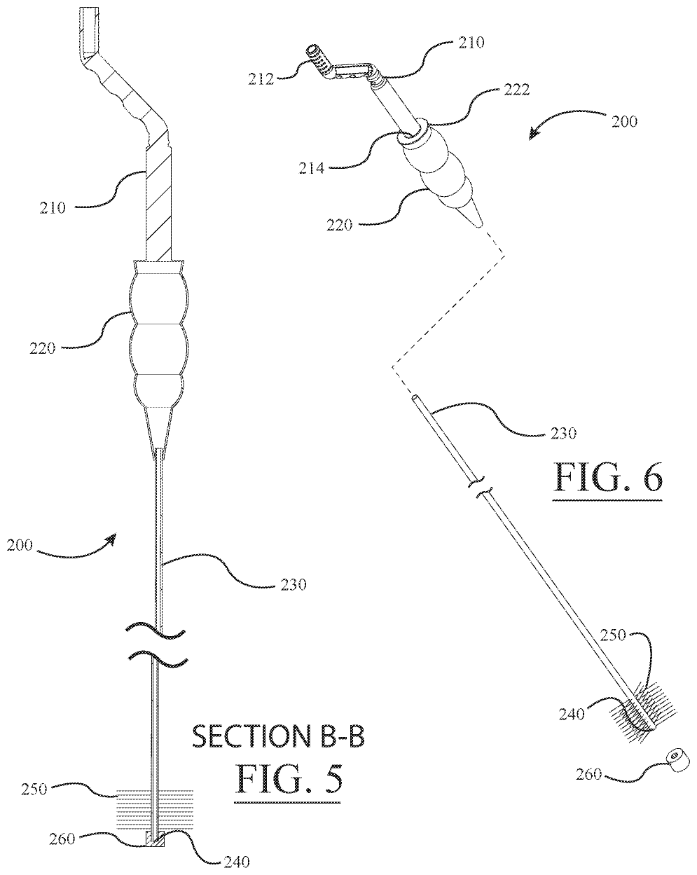

While the plurality of protruding elements on the tip section 140 of the illustrative drain cleaning device 100 are in a form of brush bristles, it is to be understood the protruding elements may take on other forms. For example, in other embodiments, the plurality of protruding elements of the drain cleaning device 100 may comprise a hook material strip (e.g., made from the hook portion of Velcro®— see e.g., FIGS. 5 and 9 of U.S. Pat. No. 10,857,577), rather than being brush bristles.

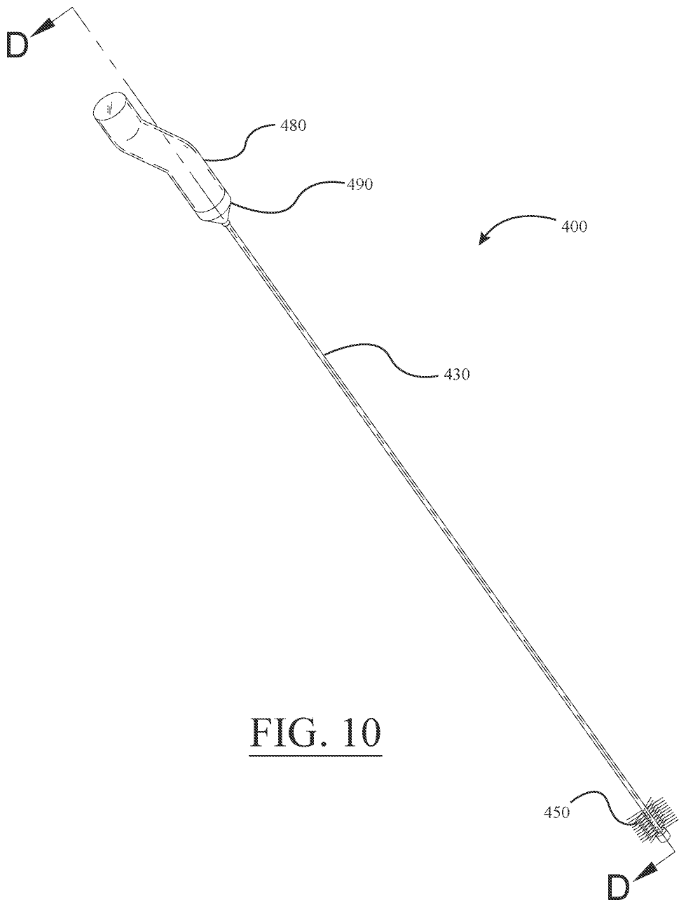

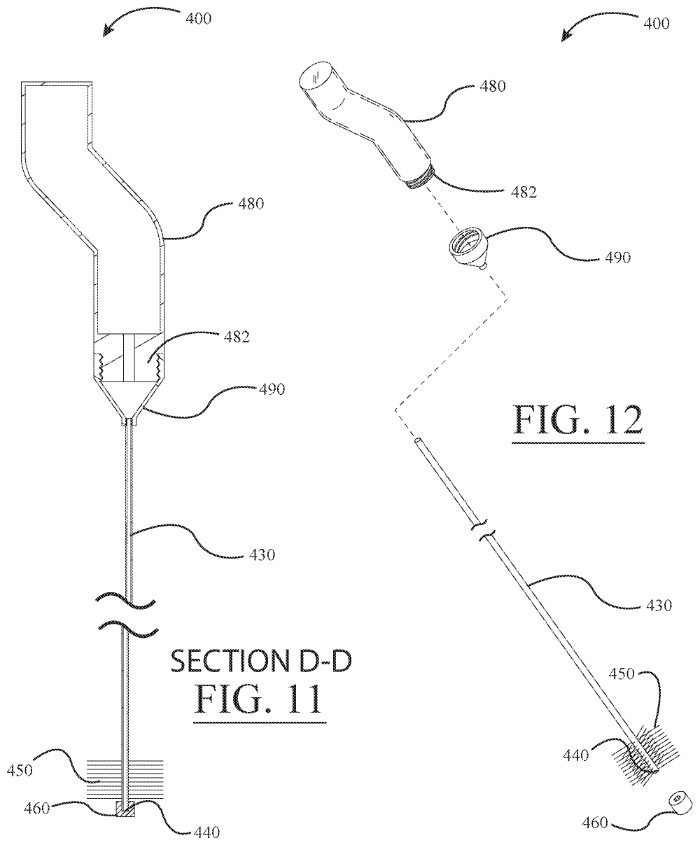

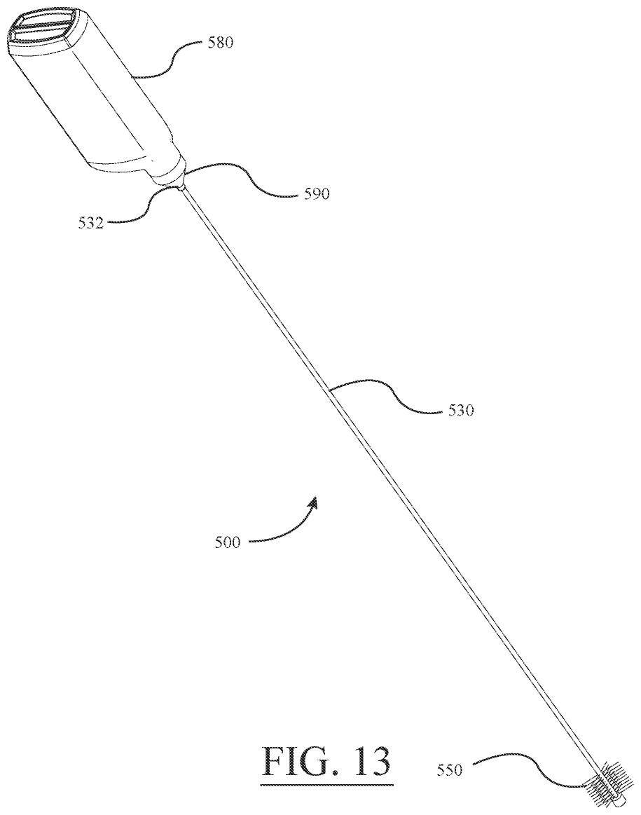

As yet another example, in other embodiments, the plurality of protruding elements on the tip section 140 of the drain cleaning device 100 may comprise a plurality of injection-molded micro-hook elements configured to grab and collect the hair and/or debris from the drain pipe being cleaned. In the these embodiments, the plurality of injection-molded micro-hook elements may be in the form of inverted J-shaped projections and T-shaped projections protruding outwardly from the central core portion of the tip section 140. The plurality of injection-molded micro-hook elements may be disposed on opposite first and second sides of the central core portion of the tip section. The injection-molded micro-hook inverted J-shaped elements that are disposed on the first side and the second side of the elongated body of the tip section 140 may be arranged in rows where every other injection-molded micro-hook element points in an opposite direction (i.e., the injection-molded micro-hook elements point in alternating directions along the length of the tip section—see e.g., FIGS. 10-12 in U.S. Pat. No. 10,857,577, the entire disclosure of which is incorporated herein by reference).

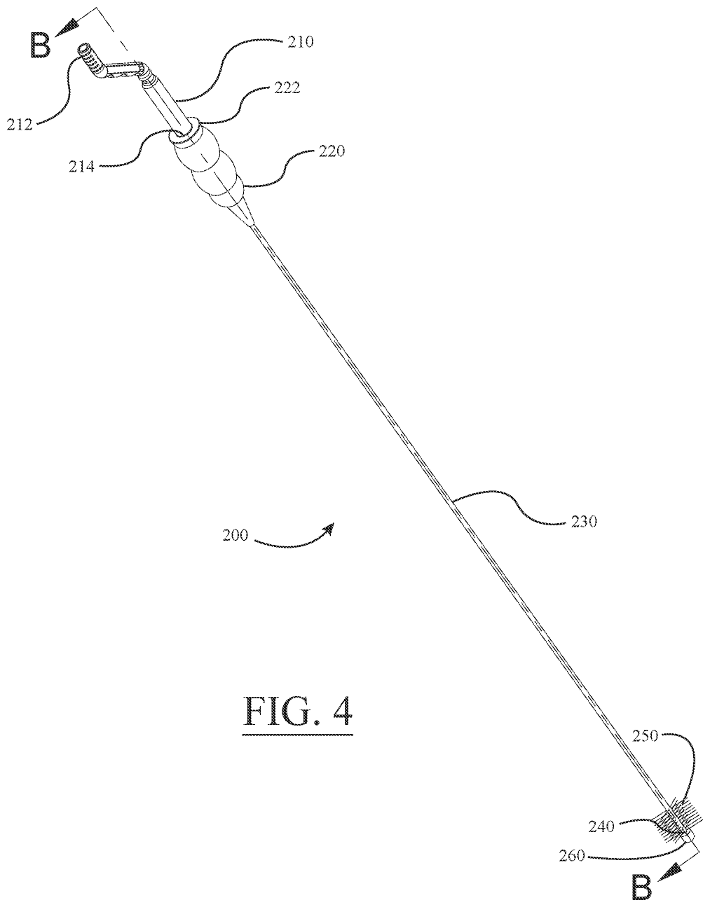

A second illustrative embodiment of a drain cleaning device is seen generally at 200 in FIGS. 4-6. Referring to these figures, it can be seen that, in many respects, the illustrative embodiment of FIGS. 4-6 is similar to that of the illustrative embodiment of FIGS. 1-3. Moreover, many elements are common to both such embodiments. For the sake of brevity, the elements that the illustrative embodiment of FIGS. 4-6 has in common with the embodiment of FIGS. 1-3 will not be discussed because these components have already been described above.

In the second illustrative embodiment, as shown in FIGS. 4-6, the drain cleaning device 200 can be a single piece design (e.g., the handle 210 is not removable), and the chemical is provided within the squeeze bulb 220. The handle 210 has a proximal end portion 212 and a distal end portion 214. In the illustrative embodiment, the distal end portion 214 of the handle 210 is connected to a proximal end portion 222 of the squeeze bulb 220. Once the chemical is depleted, the user can dispose of the drain cleaning device 200 or use it without the chemical. This can provide a disposable design and also provide for the chemical being safely contained within the squeeze bulb 220. The chemical is discharged through the elongated rod section 230, and then through the distal tip 240.

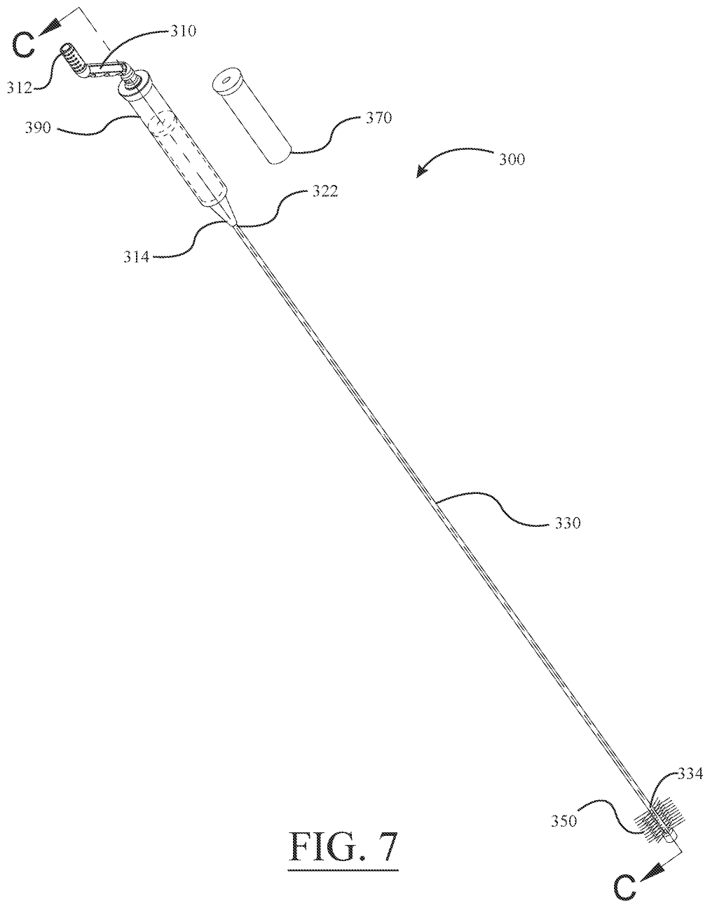

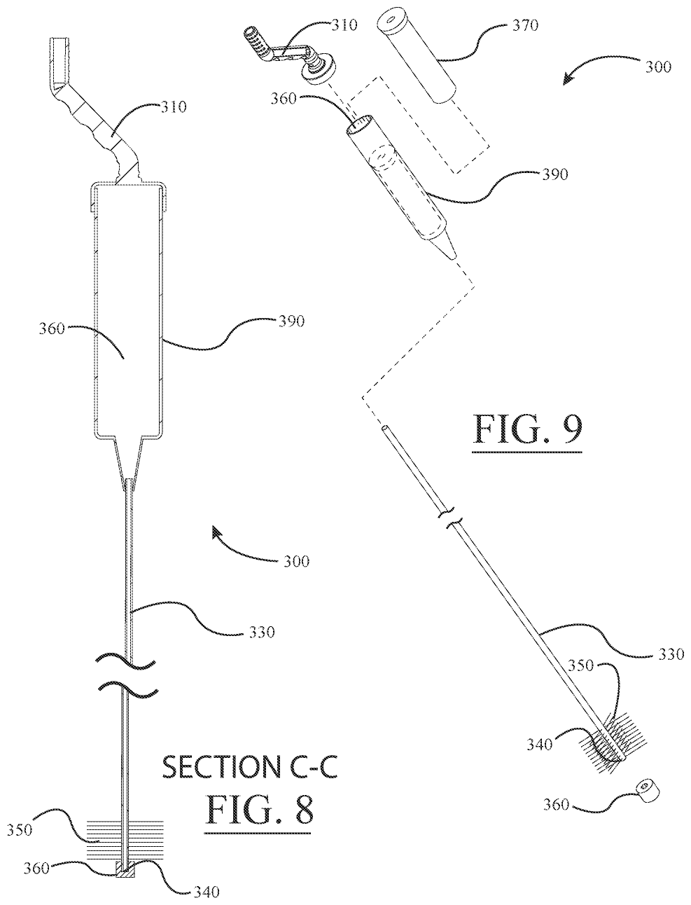

A third illustrative embodiment of a drain cleaning device is seen generally at 300 in FIGS. 7-9. Referring to these figures, it can be seen that, in many respects, the illustrative embodiment of FIGS. 7-9 is similar to that of the preceding illustrative embodiments. Moreover, many elements are common to all of these embodiments. For the sake of brevity, the elements that the illustrative embodiment of FIGS. 7-9 has in common with the preceding embodiments will not be discussed because these components have already been described above.

In the third illustrative embodiment, as shown in FIGS. 7-9, a cartridge design can be provided in which a chemical cartridge 370 containing the chemical can be inserted into a handle recess 360 of the cartridge holder 390 of the handle 310. This allows for either refillable cartridges, in which the cartridge can be refilled with the chemical, or disposable cartridges that can be disposed of when depleted. The user can install the disposable cartridge 370 within the handle 310, which will drain through the elongated rod section 330 and out of the distal tip 340. When the chemical cartridge 370 is depleted, the user can dispose of the depleted chemical cartridge 370, and install a new chemical cartridge 370 containing the chemical. The handle 310 has a proximal end portion 312 and a distal end portion 314. In the illustrative embodiment, the distal end portion 314 of the handle 310 is coupled to the first end 332 of the elongated rod section 330. The second end 334 of the elongated rod section 330 is attached to distal tip 340.

A fourth illustrative embodiment of a drain cleaning device is seen generally at 400 in FIGS. 10-12. Referring to these figures, it can be seen that, in many respects, the illustrative embodiment of FIGS. 10-12 is similar to that of the preceding illustrative embodiments. Moreover, many elements are common to all of these embodiments. For the sake of brevity, the elements that the illustrative embodiment of FIGS. 10-12 has in common with the preceding embodiments will not be discussed because these components have already been described above.

In the fourth illustrative embodiment, as shown in FIGS. 10-12, the drain cleaning device 400 can include a chemical bottle 480 that contains a chemical but is also shaped as a handle, allowing the chemical bottle 480 to function as a handle as well. The connector portion 482 of the chemical bottle 480 can screw onto the top connector portion 490 of the drain cleaning device 400. In some exemplary embodiments, the handle can allow spinning of the elongated rod section 430 and distal tip 440 when inside the drain.

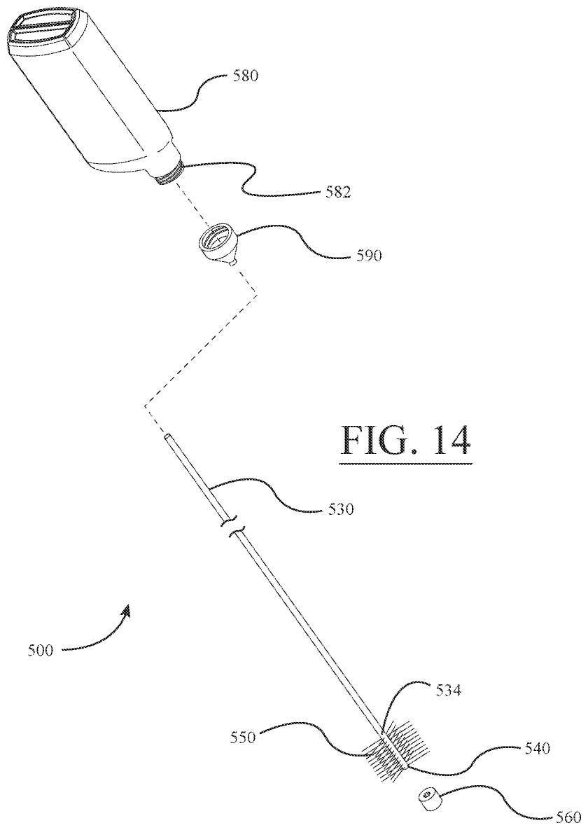

A fifth illustrative embodiment of a drain cleaning device is seen generally at 500 in FIGS. 13 and 14. Referring to these figures, it can be seen that, in many respects, the illustrative embodiment of FIGS. 13 and 14 is similar to that of the preceding illustrative embodiments. Moreover, many elements are common to all of these embodiments. For the sake of brevity, the elements that the illustrative embodiment of FIGS. 13 and 14 has in common with the preceding embodiments will not be discussed because these components have already been described above.

In the fifth illustrative embodiment, as shown in FIGS. 13 and 14, the drain cleaning device 500 can include an elongated hollow rod section 530 and a distal tip 540. A top connector portion 590 at the first end 532 of the elongated rod section 530 can have screw threads that can mate with a connector portion 582 of an existing chemical bottle 580 having a chemical. Many chemical drain cleaners come with a screw cap on the top portion of the bottle. Once this is removed, the bottle 580 can be screwed together with the top portion 590 of the drain cleaning device 500. The chemical can flow from the chemical bottle 580 into the hollow interior of the elongated rod section 530 and out of the distal tip 540. The second end 534 of the elongated rod section 530 is attached to distal tip 540.

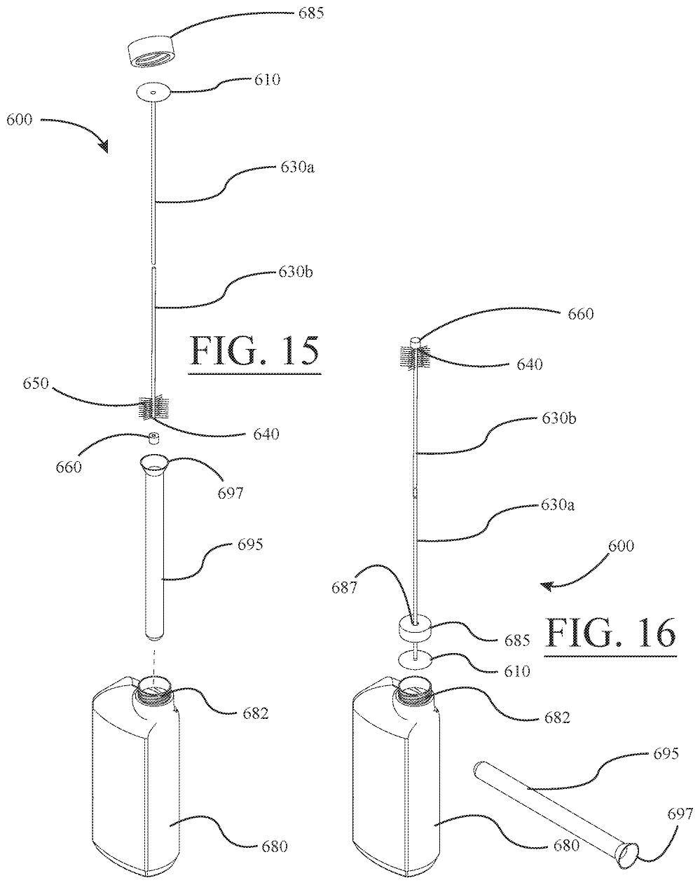

A sixth illustrative embodiment of a drain cleaning device is seen generally at 600 in FIGS. 15 and 16. Referring to these figures, it can be seen that, in some respects, the illustrative embodiment of FIGS. 15 and 16 is similar to that of the preceding illustrative embodiments. Moreover, some elements are common to all of these embodiments. For the sake of brevity, the elements that the illustrative embodiment of FIGS. 15 and 16 has in common with the preceding embodiments will not be discussed because these components have already been described above.

In the sixth illustrative embodiment, as shown in FIGS. 15 and 16, the drain cleaning device 600 can come inside a chemical bottle 680. A disposable sleeve 695 can be provided within the chemical bottle 680, and a top portion 697 of the disposable sleeve 695 can sit on a flat top portion 682 of the chemical bottle 680. The first end 610 (handle 610) of the drain cleaning device 600 can sit on the top portion 697 of the disposable sleeve 695. The drain cleaning device 600 is enclosed within the disposable sleeve 695 so that it does not get any chemical on it inside the chemical bottle 680. The elongated rod section 630 can be extendable. For example, the elongated rod 630 can have an upper tubular half 630a and a lower tubular half 630b. The lower half 630b can have a smaller diameter than the upper half 630a, and can slide inside the upper half 630a. The distal tip 640 can have a brush 650 and a plug 660. A cap or bottle lid 685 can have a through-hole 687 provided through the bottle lid 685 from the top to the bottom of the bottle lid 685. The bottle lid 685 can have screw threads (or other closing means) that mate with on the top of the chemical bottle 680, covering the handle 610 and the top portion 697 of the disposable sleeve 695.

In use, a user can remove the bottle lid 685 and remove the disposable sleeve 695 and drain cleaning device 600 from the chemical bottle 680. The drain cleaning device 600 can be removed from the disposable sleeve 695, which can be disposed of. The elongated rod section 630 of the drain cleaning device 600 can be extended by pulling the lower half 630b from the upper half 630a. Once fully extended, the upper half 630a can lock into place over the lower half 630b by any type of click locking mechanism. The bottle lid 685 can have a cover or removable film on the top portion, covering the through-hole 687. The cover or removable film can be removed, exposing the through-hole 687. The through-hole 687 of the bottle lid 685 can be inserted over the distal tip 640 of the drain cleaning device 600, as shown in FIG. 16. The handle 610 can be placed on top of the flat top portion 682 of the chemical bottle 680, and the bottle lid 685 can be screw threaded back on the chemical bottle 680, sealing the chemical bottle 680 while also locking the handle 610 into place over the chemical bottle 680. Now, the user can insert the drain cleaning device 600 into a drain, and the chemical will pour from the chemical bottle 680 down into the hollow elongated rod section 630 and out of the distal tip 640.

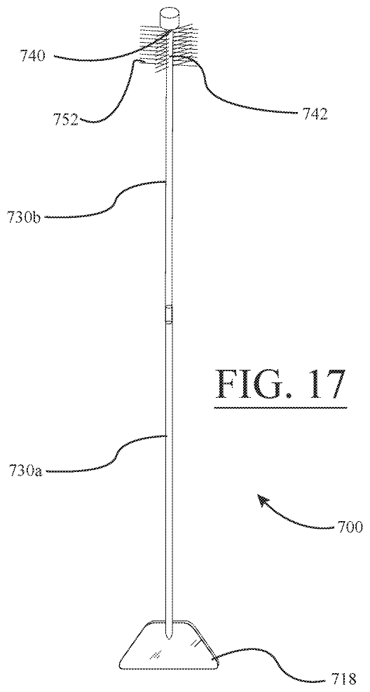

A seventh illustrative embodiment of a drain cleaning device is seen generally at 700 in FIG. 17. Referring to this figure, it can be seen that, in many respects, the illustrative embodiment of FIG. 17 is similar to that of the illustrative embodiment of FIGS. 15 and 16. Moreover, many elements are common to both of these embodiments. For the sake of brevity, the elements that the illustrative embodiment of FIG. 17 has in common with the illustrative embodiment of FIGS. 15 and 16 will not be discussed because these components have already been described above.

In the seventh illustrative embodiment, as shown in FIG. 17, a drain cleaning device 700 can be provided within a chemical bottle 680 with a disposable sleeve 695. The elongated rod section comprising first and second rod members 730a, 730b can be extended as described above, and the disposable sleeve 695 can be disposed of. In this embodiment, the elongated rod section 730a, 730b does not need to be hollow. The drain cleaning device 700 can be inserted into a drain to clean the drain, and the chemical then poured directly from the chemical bottle 680. A top portion 718 of the drain cleaning device 700 can have a flat thumb-tab for twisting the drain cleaning device 700 inside the drain. A brush 750 having a plurality of bristles 752 extending from a central core portion 742 can be provided at the distal tip 740 to help clean debris from the drain.

Various other considerations can also be addressed in the exemplary applications described according to the illustrative embodiments of the present disclosure. For example, various materials may be used to construct the elements described in the figures. Various sizes of the elements can also be provided for various sizes of drain cleaning devices. The illustrative embodiments of the present disclosure allow for a compact and portable drain cleaning device.

Various advantages can be provided by the illustrative embodiments of the present disclosure. For example, by the chemical coming out the distal tip, the chemical can be directed to the pipe wall where the waste buildup is located. The traditional method of pouring chemical down the drain results in chemical flowing past the pipe waste on the pipe wall (i.e., chemical just sits in the U trap). As described above, the elongated tips of the illustrative drain cleaning devices can also have hair grabbing protrusions such as hooks or barbs on the end helping to clean hair and other waste in conjunction with the chemical. In some exemplary embodiments, a separate chemical solution can be provided and used in conjunction with the drain cleaning device for drain odor. For example, after cleaning with the chemical, a cartridge for drain odor can be installed and used to clean the smell in that part of the drain.

In some exemplary embodiments, the elongated rod section can be designed with a small diameter to fit in any traditional sink or shower drain. This can eliminate the need to remove or take apart the drain before cleaning. The elongated rod section can also fit down a sink overflow to clean the sink overflow or for odor control in the sink overflow.

Any of the features or attributes of the above described embodiments and variations can be used in combination with any of the other features and attributes of the above described embodiments and variations as desired.

Although the invention has been shown and described with respect to a certain embodiment or embodiments, it is apparent that this invention can be embodied in many different forms and that many other modifications and variations are possible without departing from the spirit and scope of this invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A drain cleaning device for removing debris from a drain, the drain cleaning device comprising:
a fluid container section, the fluid container section comprising a fluid reservoir for holding a chemical cleaning fluid therein;
an elongated rod section having a first end and a second end oppositely disposed relative to the first end, the first end of the elongated rod section being connected to the fluid container section, the elongated rod section defining a fluid passageway configured to be fluidly coupled to the fluid reservoir of the fluid container section for conveying the chemical cleaning fluid; and
a tip section connected to the second end of the elongated rod section, the tip section including a central core portion and a plurality of protruding elements extending from the central core portion, the plurality of protruding elements configured to remove debris from a drain pipe, the tip section further including a fluid aperture fluidly coupled to the fluid passageway of the elongated rod section so as to enable the chemical cleaning fluid to be discharged from the fluid aperture of the tip section to the drain pipe.

2. The drain cleaning device according to claim 1, wherein the fluid container section is in a form of a squeeze bulb formed from a flexible material, the squeeze bulb comprising the fluid reservoir for holding the chemical cleaning fluid therein, and the squeeze bulb configured to be squeezed by a user so as to discharge the chemical cleaning fluid from the drain cleaning device.

3. The drain cleaning device according to claim 2, further comprising a detachable handle section having a proximal end portion and a distal end portion, the distal end portion of the detachable handle section being configured to be coupled to a proximal end portion of the squeeze bulb.

4. The drain cleaning device according to claim 2, wherein the fluid container section, the elongated rod section, and the tip section are formed together with a handle section as part of a one-piece device construction, the handle section having a proximal end portion and a distal end portion, the distal end portion of the handle section being connected to a proximal end portion of the squeeze bulb.

5. The drain cleaning device according to claim 1, further comprising a plug member that is configured to engage a distal end portion of the tip section, wherein the plug member is configured to prevent a leakage of the chemical cleaning fluid from the fluid aperture of the tip section.

6. The drain cleaning device according to claim 1, wherein the tip section further comprises a plurality of brush bristles attached to the central core portion, and the plurality of protruding elements of the tip section are formed by the plurality of brush bristles.

7. The drain cleaning device according to claim 1, wherein the tip section further comprises an outer covering formed from a hook material strip that is bonded to the central core portion of the tip section, the hook material strip forming the plurality of protruding elements of the tip section.

8. The drain cleaning device according to claim 1, wherein the plurality of protruding elements are in a form of a plurality of injection-molded micro-hook elements.

9. The drain cleaning device according to claim 1, further comprising a handle section having a proximal end portion and a distal end portion, the distal end portion of the handle section being configured to be coupled to the first end of the elongated rod section; and
wherein the fluid container section is in a form of a removable cartridge configured to be selectively engaged with the handle section, the removable cartridge comprising the fluid reservoir for holding the chemical cleaning fluid therein, and the removable cartridge configured to be replaceable by a user when the chemical cleaning fluid is emptied from the removable cartridge.

10. The drain cleaning device according to claim 1, wherein the fluid container section is in a form of a detachable bottle that includes a first connector portion, the detachable bottle comprising the fluid reservoir for holding the chemical cleaning fluid therein, and the first end of the elongated rod section comprising a second connector portion that is configured to engage with the first connector portion on the detachable bottle for removably coupling the detachable bottle to the elongated rod section.

11. The drain cleaning device according to claim 1, wherein the fluid container section is in a form of a detachable handle that includes a first connector portion, the detachable handle comprising the fluid reservoir for holding the chemical cleaning fluid therein, and the first end of the elongated rod section comprising a second connector portion that is configured to engage with the first connector portion on the detachable handle for removably coupling the detachable handle to the elongated rod section.

12. The drain cleaning device according to claim 1, wherein the fluid container section is in a form of a bottle that includes a bottle cap member, the bottle comprising the fluid reservoir for holding the chemical cleaning fluid therein, and the elongated rod section and the tip section of the drain cleaning device are configured to be housed inside the bottle.

13. The drain cleaning device according to claim 12, further comprising a sleeve member configured to be inserted into the bottle, the elongated rod section and the tip section of the drain cleaning device configured to be housed within the sleeve member inside the bottle so as to isolate the elongated rod section and the tip section of the drain cleaning device from the chemical cleaning fluid when the elongated rod section and the tip section of the drain cleaning device are being stored inside the bottle.

14. The drain cleaning device according to claim 13, wherein, when the drain cleaning device is ready to be used, the sleeve member, and the elongated rod section and the tip section of the drain cleaning device housed therein are configured to be removed from the inside of the bottle, and the first end of the elongated rod section of the drain cleaning device is configured to be attached to a mouth of the bottle by means of the bottle cap member so that the chemical cleaning fluid from the fluid reservoir of the bottle is able to be discharged from the fluid aperture of the tip section.

15. The drain cleaning device according to claim 14, wherein the elongated rod section of the drain cleaning device comprises a first tubular member telescopically received within a second tubular member, the second tubular member configured to be extended from the first tubular member so as to increase an overall length of the drain cleaning device for reaching deeper into the drain pipe.

16. A drain cleaning device for removing debris from a drain, the drain cleaning device comprising:
a handle section, the handle section configured to accommodate a hand of a user during a spinning of the drain cleaning device by the user;
an elongated rod section having a first end and a second end oppositely disposed relative to the first end, the first end of the elongated rod section being connected to the handle section; and
a tip section connected to the second end of the elongated rod section, the tip section including a central core portion and a plurality of protruding elements extending from the central core portion, the plurality of protruding elements configured to remove debris from the drain pipe;
wherein the drain cleaning device is configured to be stored inside a fluid container, the fluid container comprising a fluid reservoir for holding a chemical cleaning fluid therein, and the fluid container further comprising a cap member configured to enclose the drain cleaning device within the fluid container.

17. The drain cleaning device according to claim 16, further comprising a sleeve member configured to be inserted into the fluid container, the elongated rod section and the tip section of the drain cleaning device configured to be housed within the sleeve member inside the fluid container so as to isolate the elongated rod section and the tip section of the drain cleaning device from the chemical cleaning fluid when the elongated rod section and the tip section of the drain cleaning device are being stored inside the fluid container.

18. The drain cleaning device according to claim 16, wherein the elongated rod section of the drain cleaning device comprises a first rod member telescopically received within a second rod member, the second rod member configured to be extended from the first rod member so as to increase an overall length of the drain cleaning device for reaching deeper into the drain pipe.
